(19) United States
(12) Patent Application Publication
(10) Pub. No.: US 2004/0001251 A1
(43) Pub. Date: Jan. 1, 2004

(54) HOLLOW ROD

(76) Inventor: Chih-Shun Huang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/250,279

(22) Filed: Jun. 19, 2003

(30) Foreign Application Priority Data
Jun. 26, 2002 (TW) 091209989

(51) Int. Cl. G02B 21/00

(52) U.S. Cl. 359/368

(57) ABSTRACT

A hollow rod according to the invention includes four plates, and each of the plates has upper and lower edges. The upper edge is provided with at least a projection, and a position corresponding to the projection is provided with at least a recess having a shape corresponding to that of the projection. The projection of each plate is inserted into the recess of another plate adjacent to the upper edge thereof. The edges of the plates are inserted with one another for forming a hollow rod, thereby reinforcing strength and heat resistance.

### BACKGROUND OF INVENTION

1. Field of the Invention

This invention relates to a rod used in optical systems, and more particularly to a hollow rod.

2. Description of the Prior Art

In a projection device, a rod therein is considered as an important component. Using internal reflecting surfaces of the hollow rod, light beams are reflected several times for achieving even illumination effects. Referring to FIG. 1, according to a prior projection device, an optical system 20 comprises a light source 21 for producing light beams 22. The light beams 22 are focused to a color wheel 24 by a converging lens 23 after being reflected by a parabolic reflector 211. The light beams 22 are intercepted by red, green and blue filters of the color wheel 24, and are transformed into colored light beams 221. The colored light beams 221 are passed through a rod 25 having even light intensity, and are projected to a prism 30 after passing through and modulated by a condenser lens 26, a stop 27 and a relay lens 28. Next, the light beams 221 are reflected to a light valve 10 by a mirror 31. The light valve 10 then projects images containing information through the prism 30 to a projection lens 32, and finally to a screen 33.

Referring to FIG. 2, the prior art rod is a hollow, rectangular and pipe-like object. The rod 25 is formed by surrounding upper and lower plates 252, and left and right plates 253, which all have a total reflection coating 251, respectively. Outer edges of junctions of the upper and lower plates 252, and the left and right plates 253, are all applied with adhesive 254 for allowing light beams to pass through. After multiple random reflections, the light beams are able to give a more evenly distributed illumination. However, a volume of the rod using the aforesaid joining method is rather large and has higher component material costs as well. Referring to FIG. 3, in order to simplify the volume and components, another prior art rod 40 comprises four plates 41 of same sizes is developed, wherein end portions on sides of the plates are adhered to one another using adhesive 42, so as to form a more simplified hollow and rectangular rod. Yet, the adhesive 42 is likely to exude from an inner periphery 43 via junctions, which then hinder even illumination effects of the rod 40.

In addition, to obtain brighter and clearer images projected onto a screen, high-power light bulbs are frequently utilized in common projection devices. However, high-temperature light beams emitted from the light source 21 and converged by the converging lens 23, form light beams that have higher temperatures and are projected to the rods 25 and 40. After long illumination, and especially after illumination to ultraviolet and infrared rays, adhered portions at the rods 25 and 40 are liable to become brittle. As a result, the rods 25 and 40 may collapse and thus affecting qualities thereof.

### SUMMARY OF INVENTION

An object of this invention is, therefore, to provide a hollow rod for reinforcing strength and raising heat-resistance thereof.

Another object of this invention is to provide a hollow rod with simplified fabrications, thereby reducing work time required for elevating efficiency thereof.

To achieve the aforesaid objects, a rod according to the invention comprises four plates, and each plate has upper and lower edges. The upper edge is provided with at least a projection, and a position at the lower edge corresponding to the projection is provided with at least a recess having a shape corresponding to that of the projection. The projection of each plate is inserted into the recess of another plate adjacent to the upper edge thereof, thereby forming a hollow rod by inserting edges of the plates with one another.

### BRIEF DESCRIPTION OF DRAWINGS

FIG. 1 is a diagram showing the optical path of a prior art projection device.

FIG. 2 shows a structural sectional view of a prior art rod.

FIG. 3 shows a structural sectional view of another prior art rod.

FIG. 4 shows a perspective view according to the invention.

FIG. 5 shows a top view illustrating a plate of the rod according to the invention.

FIG. 6 shows a perspective view illustrating a plate in another embodiment according to the invention.

FIG. 7 shows a perspective view illustrating a rod in another embodiment according to the invention.

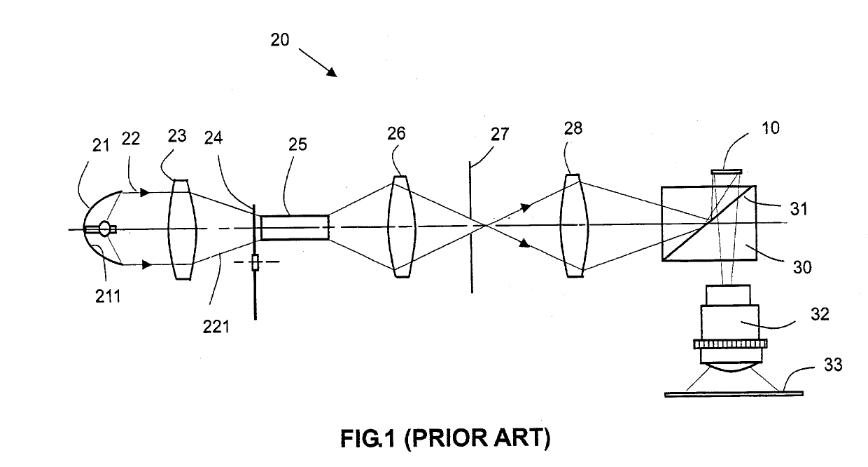

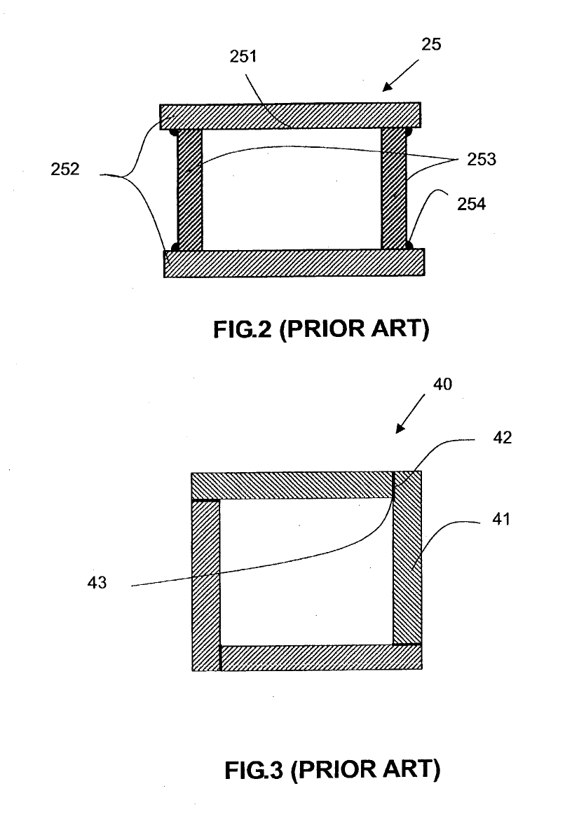

### DETAILED DESCRIPTION

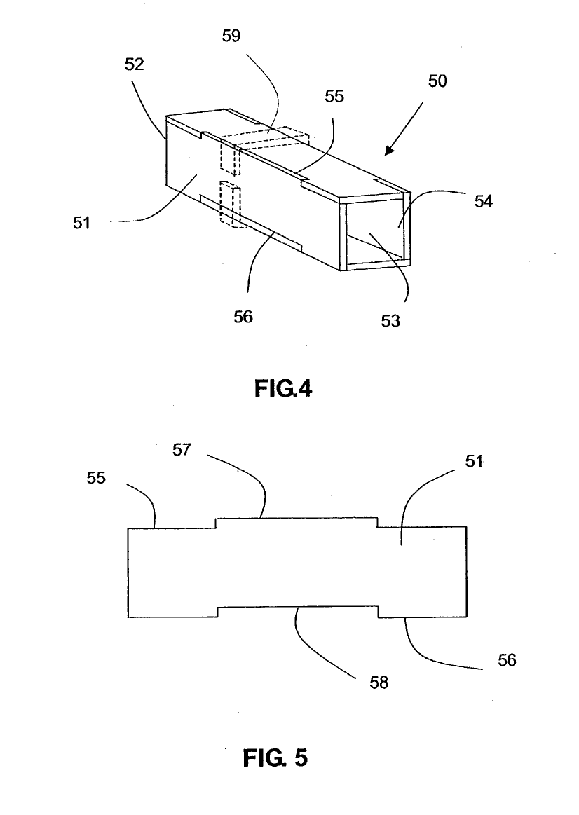

Referring to FIG. 4, a rod 50 according to the invention comprises four plates 51 having identical shapes for forming four sides thereof. A hollow pipe-like object having a rectangular sectional area is constructed by inserting end portions of the plates 51 to one another. Two ends of the pipe-like object are an input aperture 52 and an output aperture 53. Internal surfaces of the hollow rod 50 are applied with a reflection coating 54, so as to provide light beams entering the rod 50 with multi-reflections for even illumination.

Referring to FIG. 5, each plate 51 of the rod 50 according to the invention is a long board having an upper edge 55 and a lower edge 56. A middle portion of the upper edge 55 is a projection 57, and a corresponding middle portion of the lower edge 56 is disposed with a recess 58 having a shape coordinating with that of the projection 57.

To assemble the rod 50 according to the invention, upper edges 55 and lower edges 56 of the four identical plates 51 are joined in a front-to-end manner, such that the projection 57 of each plate 51 is inserted into the recess 58 of another plate 51 adjacent to the upper edge 55 thereof. Using tight relationship formed between the projections 57 and the recesses 58, a hollow and rectangular pipe-like rod 50 free of adhesive is constructed with the four plates 51 serving as side walls, thereby being heat-resistant under illuminations of high-temperature light beams. Therefore, the assembly according to the invention provides a rod having a small volume, reduces steps of accurate positioning and adhering, and economizes equipment expenses of adhering machinery. In addition, the rod according to the invention is directly assembled by inserting, thereby simplifying assembly thereof as well as preventing adhesive from exuding and affecting reflections of internal surfaces of the rod.

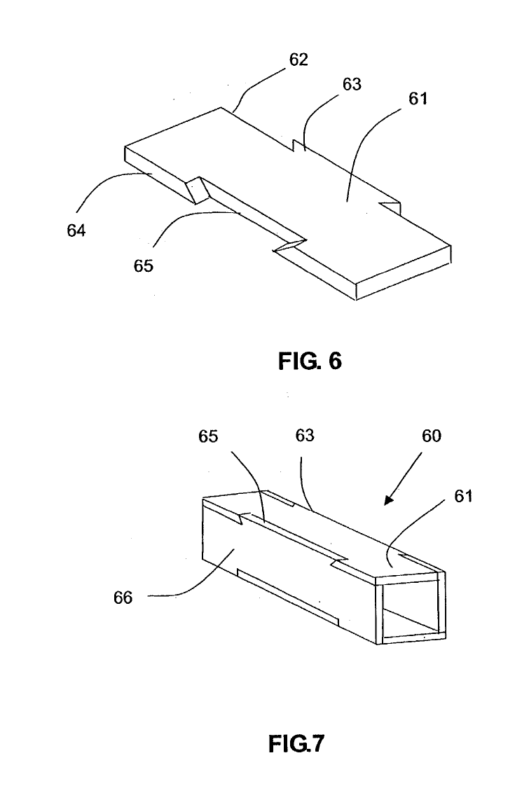

Similarly, referring to FIG. 6, for a plate 61 of a rod according to the invention, a middle portion of an upper edge 62 of the plate 61 is provided with a dovetailed projection 62, and a position at a middle portion of a lower edge 64 corresponding to the dovetailed projection 63 is provided with an recess 65 having a shape corresponding to that of the dovetailed projection 63. Four plates 61 are utilized to form four sides of a rod 60, such that the dovetailed projection 63 of each plate is inserted into the recess 65 of another plate 61 adjacent to the upper edge 62 thereof, thereby forming a rod 60 having an even simpler assembly. Furthermore, referring to FIG. 7, the rod 60 may also have upper and lower plates 61 having larger heights than those of the left and right plates 66, so as to form a trapezoidal shape when required. Apart from at least one projection and at least one recess formed at two edges of each plate 51 or 61, an outer periphery of the rod according to the invention may also be disposed with an elastic fastening band 59 for supporting and securing the four plates 51, and for reinforcing the structure as a whole.

While a preferred and particular embodiment of the present invention have been described herein for purposes of illustration, many modifications and changes will become apparent to those skilled in the art. Accordingly, the appended claims are intended to encompass all such modifications and changes as fall within the true spirit and scope of this invention.

1. A hollow rod comprising four plates, and the each plate having upper and lower edges, wherein the upper edge is provided with at least a projection, and a corresponding position of the lower edge is provided with at least a recess having a shape corresponding to the projection for inserting the projection of each plate into the recess of another plate adjacent to the upper edge thereof, and further forming a hollow rod.

2. The hollow rod of claim 1, wherein the plate is a long board, and has a projection and a recess that correspond to each other at middle portions of the upper and lower edges, respectively.

3. The hollow rod of claim 1, wherein the projection is a dovetailed projection.

4. The hollow rod of claim 1, wherein the upper and lower plates, and the left and right plates of the rod have different heights to form a rectangular sectional area.

5. The hollow rod of claim 1, wherein the four plates have different heights to form a trapezoidal sectional area.

6. The hollow rod of claim 1, wherein an outer periphery of the four plates is disposed with an elastic fastening band.
